(19) United States
(12) Patent Application Publication
(10) Pub. No.: US 2024/0313258 A1
(43) Pub. Date: Sep. 19, 2024

(54) BATTERY CELL FOR LITHIUM ION BATTERY

(71) Applicant: Thomas Gerhard Wilhelm Damitz, Qingdao (CN)

(72) Inventor: Thomas Gerhard Wilhelm Damitz, Qingdao (CN)

(21) Appl. No.: 18/576,620

(22) PCT Filed: Jul. 4, 2022
(86) PCT No.: PCT/CN2022/103629

§ 371 Date: Jan. 4, 2024

(30) Foreign Application Priority Data
Jul. 5, 2021 (CN) 202121511617.1

(51) Int. Cl. H01M 10/0525; H01M 4/04; H01M 4/485; H01M 4/525; H01M 4/583; H01M 10/0585

(52) U.S. Cl. CPC H01M 10/0525; H01M 4/0404; H01M 4/485; H01M 4/525; H01M 4/583; H01M 10/0585

(57) ABSTRACT

A battery cell(100) for a lithium ion battery is provided, which comprises: an anode piece(101), the anode piece(101) being coated with an active substance; a cathode piece(102) disposed opposite to the anode piece(101), the cathode piece(102) being coated with an active substance; a separator(103) and an electrolyte(104) disposed between the anode piece(101) and the cathode piece(102); and a case(105) encapsulating the anode piece(101), the cathode piece(102), the separator(103) and the electrolyte(104), wherein a thickness of the active substance on the anode piece(101) is 5-30 μm, and a thickness of the active substance on the cathode piece(102) is 5-30 μm. This disclosure also relates to a lithium ion battery comprising two or more said battery cells.

### TECHNICAL FIELD

The present disclosure relates generally to a lithium ion battery, and more specifically to a battery cell for a lithium ion battery.

### BACKGROUND

Rechargeable lithium ion batteries have been implemented as a power source into a wide variety of stationary and portable applications. Their structure and electrochemical reaction mechanism provide them with several desirable characteristics including a relatively high energy density, a relatively low internal resistance, a general non-appearance of any memory effect when compared to other types of rechargeable batteries, for example, nickel-cadmium batteries, and a low self-discharge rate. These characteristics have made lithium ion batteries the preferred mobile power source for portable consumer electronics such as laptop computers and cell phones.

Typically, a lithium ion battery comprises two or more battery cells. Each battery cell comprises an anode piece, a cathode piece disposed opposite to the anode piece, a separator and an electrolyte disposed between the anode piece and the cathode piece, and a case encapsulating the anode piece, the cathode piece, the separator and the electrolyte.

### SUMMARY

The present disclosure provides a battery cell for a lithium ion battery, which comprises: an anode piece, the anode piece being coated with an active substance; a cathode piece disposed opposite to the anode piece, the cathode piece being coated with an active substance; a separator and an electrolyte disposed between the anode piece and the cathode piece; and a case encapsulating the anode piece, the cathode piece, the separator and the electrolyte, wherein a thickness of the active substance on the anode piece is 5-30 μm, and a thickness of the active substance on the cathode piece is 5-30 μm.

In an embodiment, an areal density of the active substance on the anode piece is 10-30 g/m².

In an embodiment, an areal density of the active substance on the cathode piece is 10-30 g/m².

In an embodiment, an error range of the areal density of the active substance on the anode piece is ±0.5%.

In an embodiment, an error range of the areal density of the active substance on the cathode piece is ±0.5%.

In an embodiment, the active substance on the anode piece comprises one or more of lithium cobalt oxides, lithium nickel oxide, lithium manganese oxide, nickel cobalt manganese ternary material, nickel cobalt aluminum ternary material, and lithium iron phosphate.

In an embodiment, the active substance on the cathode piece comprises one or more of graphite, silicon carbide, hard carbon, and lithium titanium oxide.

The present disclosure also provides a lithium ion battery comprising two or more said battery cells.

In accordance with the present disclosure, due to the reduction of coating thicknesses of the anode piece and the cathode piece, the amount of suction of active substances on the anode piece and the cathode piece is increased, the transmission distance of lithium ions between the anode and the cathode during the fast charging and discharging of the lithium ion battery is decreased, thereby reducing polarization of the lithium ion battery in the process of charging and discharging, and enhancing the fast charging and discharging ability of the lithium ion battery.

In accordance with the present disclosure, since the error range of the areal density of the active substance on the anode piece or the cathode piece is ±0.5%, the active substance interface reaction consistency in the lithium ion battery during charging and discharging process is increased, and uneven adsorption of electrolyte on the surfaces coated with the active substance is avoided, thereby increasing cycle life of the lithium ion battery.

### BRIEF DESCRIPTION OF THE DRAWINGS

FIG. 1 schematically shows a battery cell for a lithium ion battery in accordance with an embodiment of the present disclosure.

### DETAILED DESCRIPTION OF PREFERRED EMBODIMENTS

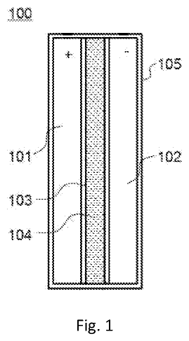

FIG. 1 schematically shows a battery cell 100 for a lithium ion battery in accordance with an embodiment of the present disclosure. Two or more battery cells 100 may be assembled to form a lithium ion battery. As shown in FIG. 1, the battery cell 100 may comprise an anode piece 101, a cathode piece 102 disposed opposite to the anode piece 101, a separator 103 and an electrolyte 104 disposed between the anode piece 101 and the cathode piece 102. The battery cell 100 may further comprise a case 105 encapsulating the anode piece 101, the cathode piece 102, the separator 103 and the electrolyte 104.

In accordance with an embodiment of the present disclosure, the anode piece 101 may be coated with an active substance and the cathode piece 102 may be coated with an active substance.

In an embodiment, a thickness of the active substance on the anode piece 101 is 5-30 μm

In an embodiment, a thickness of the active substance on the cathode piece 102 is 5-30 μm.

In an embodiment, an areal density of the active substance on the anode piece 101 is 10-30 g/m².

In an embodiment, an areal density of the active substance on the cathode piece 102 is 10-30 g/m².

In an embodiment, an error range of the areal density of the active substance on the anode piece 101 is ±0.5%.

In an embodiment, an error range of the areal density of the active substance on the cathode piece 102 is ±0.5%.

In an embodiment, the active substance on the anode piece 101 may comprise one or more of lithium cobalt oxides, lithium nickel oxide, lithium manganese oxide, nickel cobalt manganese ternary material, nickel cobalt aluminum ternary material, and lithium iron phosphate.

In an embodiment, the active substance on the cathode piece 102 may comprise one or more of graphite, silicon carbide, hard carbon, and lithium titanium oxide.

The present disclosure also provides a lithium ion battery comprising two or more said battery cells 100.

In accordance with the present disclosure, due to the reduction of coating thicknesses of the anode piece and the cathode piece, the amount of suction of active substances on the anode piece and the cathode piece is increased, the transmission distance of lithium ions between the anode and the cathode during the fast charging and discharging of the lithium ion battery is decreased, thereby reducing polarization of the lithium ion battery in the process of charging and discharging, and enhancing the fast charging and discharging ability of the lithium ion battery.

In accordance with the present disclosure, since the error range of the areal density of the active substance on the anode piece or the cathode piece is ±0.5%, the active substance interface reaction consistency in the lithium ion battery during charging and discharging process is increased, and uneven adsorption of electrolyte on the surfaces coated with the active substance is avoided, thereby increasing cycle life of the lithium ion battery.

Although a number of embodiments of this disclosure have been described, a person of ordinary skill in the art would recognize that certain modifications would come within the scope of this disclosure. For that reason, the appended claims should be studied to determine the true scope and content of this disclosure.

1. A battery cell for a lithium ion battery, comprising:
an anode piece, the anode piece being coated with an active substance;
a cathode piece disposed opposite to the anode piece, the cathode piece being coated with an active substance;
a separator and an electrolyte disposed between the anode piece and the cathode piece; and
a case encapsulating the anode piece, the cathode piece, the separator and the electrolyte,
wherein a thickness of the active substance on the anode piece is 5-30 μm, and a thickness of the active substance on the cathode piece is 5-30 μm.

2. The battery cell of claim 1, wherein an areal density of the active substance on the anode piece is 10-30 g/m².

3. The battery cell of claim 1, wherein an areal density of the active substance on the cathode piece is 10-30 g/m².

4. The battery cell of claim 2, wherein an error range of the areal density of the active substance on the anode piece is ±0.5%.

5. The battery cell of claim 3, wherein an error range of the areal density of the active substance on the cathode piece is ±0.5%.

6. The battery cell of claim 1, wherein the active substance on the anode piece comprises one or more of lithium cobalt oxides, lithium nickel oxide, lithium manganese oxide, nickel cobalt manganese ternary material, nickel cobalt aluminum ternary material, and lithium iron phosphate.

7. The battery cell of claim 1, wherein the active substance on the cathode piece comprises one or more of graphite, silicon carbide, hard carbon, and lithium titanium oxide.

8. A lithium ion battery, comprising two or more battery cells of claim 1.
